(19) United States
(12) Patent Application Publication
(10) Pub. No.: US 2011/0320720 A1
(43) Pub. Date: Dec. 29, 2011

(54) Cache Line Replacement In A Symmetric Multiprocessing Computer

(75) Inventors: Craig Walters, Poughkeepsie, NY (US); Vijayalakshmi Srinivasan, Yorktown Heights, NY (US)

(73) Assignee: INTERNATIONAL BUSINESS MACHINES CORPORATION, Armonk, NY (US)

(21) Appl. No.: 12/821,827

(22) Filed: Jun. 23, 2010

(51) Int. Cl. G06F 12/08; G06F 12/00

(52) U.S. Cl. 711/122; 711/133; 711/130; 711/E12.001; 711/E12.022; 711/E12.038; 711/E12.024

(57) ABSTRACT

Cache line replacement in a symmetric multiprocessing computer, the computer having a plurality of processors, a main memory that is shared among the processors, a plurality of cache levels including at least one high level of private caches and a low level shared cache, and a cache controller that controls the shared cache, including receiving in the cache controller a memory instruction that requires replacement of a cache line in the low level shared cache; and selecting for replacement by the cache controller a least recently used cache line in the low level shared cache that has no copy stored in any higher level cache.

### BACKGROUND OF THE INVENTION

1. Field of the Invention

The field of the invention is data processing, or, more specifically, methods, apparatus, and products for cache line replacement in a symmetric multiprocessing computer.

2. Description Of Related Art

Contemporary high performance computer systems, such as, for example, the IBM System z series of mainframes, are typically implemented as multi-compute node, symmetric multiprocessing (‘SMP’) computers with many compute nodes. SMP is a multiprocessor computer hardware architecture where two or more, typically many more, identical processors are connected to a single shared main memory and controlled by a single operating system. Most multiprocessor systems today use an SMP architecture. In the case of multi-core processors, the SMP architecture applies to the cores, treating them as separate processors. Processors may be interconnected using buses, crossbar switches, mesh networks, and the like. Each compute node typically includes a number of processors, each of which has at least some local memory, at least some of which is accelerated with cache memory. The cache memory can be local to each processor, local to a compute node shared across more than one processor, or shared across compute nodes. All of these architectures require maintenance of cache coherence among the separate caches.

In a computer with multiple levels of caches, the caches form a vertical structure with smaller caches towards the processor and consistently larger caches, called L1-L2-L3-L4, moving towards main memory. As data within this type of system is aged out from a given level of cache, due to more recent memory operations requiring storage space, cache lines move from L1 to L2, then from L2 to L3, from L3 to L4, with an eventual write back to main memory as the eviction process completes.

When a cache line is first written into a full cache, a cache controller selects a line in the cache to be replaced according to a cache replacement policy. Examples of traditional cache replacement policies include Least Recently Used (‘LRU’), Most Recently Used (‘MRU’), Pseudo-LRU, Segmented LRU, Least Frequently Used (‘LFU’), Adaptive Replacement Cache (‘ARC’), the Multi Queue (‘MQ’) caching algorithm—and others as will occur to those of skill in the art.

Least recently used (‘LRU’) algorithms are commonly used to select a cache line for replacement. Such LRU algorithms tend to focus on a protocol of recency-of-use eviction based on design restrictions of connectivity (x groups of y), as determined by the effective performance implications of the cache level and standard workloads run on the system. A typical LRU algorithm maintains a set of recency-of-use bits, sometimes referred to as ‘LRU bits,’ for each associativity within a given cache structure, such that upon selecting a line for replacement, the LRU algorithm indexes the LRU bits to determine which compartment in the associativity to select. In some cases, a prefiltering of lines occurs, in order to find empty/invalid compartments for use prior to replacing a cache line, or to avoid using compartments tagged as in a bad state. Current LRU algorithms when used to replace a cache line in a lower level cache, however, often replace cache lines that are actually more useful to retain in cache than more recently used cache lines because the replaced cache lines are still stored in higher level caches.

### SUMMARY OF THE INVENTION

Methods, apparatus, and computer program products for cache line replacement in a symmetric multiprocessing computer, the computer having a plurality of processors, a main memory that is shared among the processors, a plurality of cache levels including at least one high level of private caches and a low level shared cache, and a cache controller that controls the shared cache, including receiving in the cache controller a memory instruction that requires replacement of a cache line in the low level shared cache; and selecting for replacement by the cache controller a least recently used cache line in the low level shared cache that has no copy stored in any higher level cache.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a functional block diagram of an example of a symmetric multiprocessing computer that implements cache line replacement according to embodiments of the present invention.

FIG. 2 sets forth a flow chart illustrating an example method of cache line replacement in a symmetric multiprocessing computer according to embodiments of the present invention.

FIG. 3 sets forth a functional block diagram of an example of a multi-node symmetric multiprocessing computer that implements cache line replacement according to embodiments of the present invention.

FIG. 4 illustrates an example form of computer readable media bearing program code which executable on an SMP computer, an article of manufacture that is a computer program product according to embodiments of the present invention.

### DETAILED DESCRIPTION OF EXAMPLE EMBODIMENTS

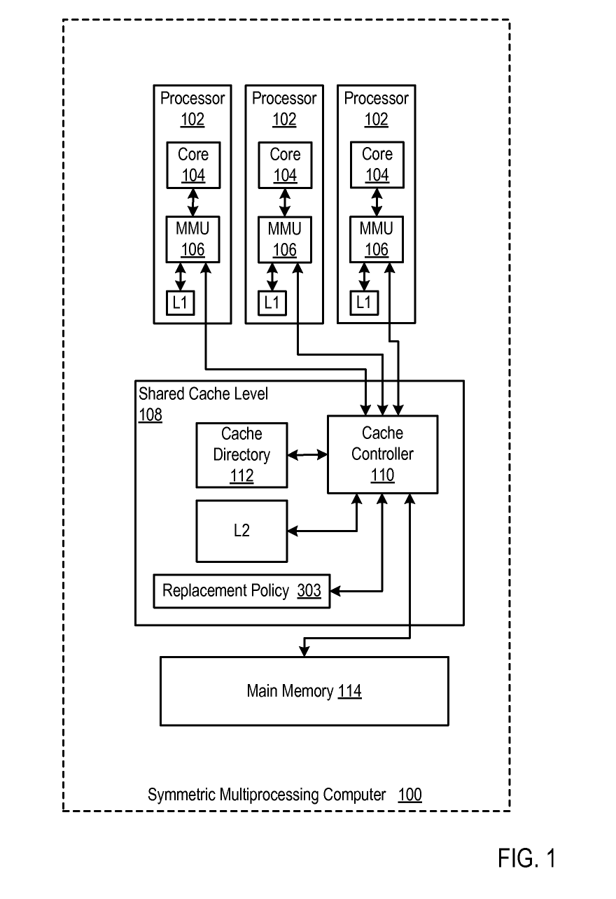

Example methods, apparatus, and computer program products for cache line replacement in a symmetric multiprocessing computer according to embodiments of the present invention are described with reference to the accompanying drawings, beginning with FIG. 1. FIG. 1 sets forth a functional block diagram of an example symmetric multiprocessing computer (100) that implements cache line replacement according to embodiments of the present invention.

The example computer (100) in FIG. 1 includes several computer processors (102). Each processor (102) includes a compute core (104) that is coupled for memory operations through a memory management unit (‘MMU’) (106) and a cache controller (110) to two caches L1 and L2, and to main memory (114). L1 is a relatively small, high speed cache fabricated into the processor itself, on the same chip. The MMU (106) includes address translation logic, a translation lookaside buffer, controls for the on-processor cache L1, and so on.

The main memory (114) is the principal, random access store of program data and program instructions for data processing on the computer (100). Main memory (114) is characterized by memory latency, the time required for a memory access, a read or write to or from main memory. Main memory (114) implements a single extent of physical address space shared among the processor (102).

The caches L1 and L2 are specialized segments of memory used by the processors (102) to reduce memory access latency. Each cache is smaller and faster than main memory, and each cache stores copies of data from frequently used main memory locations. When a processor needs to read from or write to a location in main memory, it first checks whether a copy of that data, a “cache line,” is in a cache. If so, the processor immediately reads from or writes to the cache, which is much faster than reading from or writing to main memory. As long as most memory accesses are cached memory locations, the average latency of memory accesses will be closer to the cache latency than to the latency of main memory. As mentioned, main memory is much slower than any cache, and cache misses extract a heavy toll in memory access latency.

Cache memory is organized in blocks of data referred to as ‘cache lines.’ Each cache line in different designs may range in size from 8 to 512 bytes or more. The size of a cache line typically is larger than the size of the usual access requested by a CPU instruction, which ranges from 1 to 16 bytes—the largest addresses and data typically handled by current 32 bit- and 64 bit-architectures being 128 bits or 16 bytes in length. Each cache line is characterized by a ‘tag’ composed of most significant bits of the beginning address where the contents of the cache line are stored in main memory.

In the example of FIG. 1, caches L1 and L2 implement a multi-level cache with two levels. Multi-level caches address the tradeoff between cache latency and hit rate. Larger caches have better hit rates but longer latency. To address this tradeoff, many computers use multiple levels of cache, with small fast caches backed up by larger slower caches. Multi-level caches generally operate by checking the smallest Level 1 (L1) cache first; if it hits, the processor proceeds at high speed. If the smaller cache misses, the next larger cache (L2) is checked, and so on, before main memory is checked. The example computer of FIG. 1 implements two cache levels, but this is only for ease of explanation, not for limitation. Many computers implement additional levels of cache, three or even four cache levels. Some processors implement as many as three levels of on-chip cache. For example, the Alpha 21164™ has a 96 KB on-die L3 cache, and the IBM POWER4™ has a 256 MB L3 cache off-chip, shared among several processors.

The cache controller (110) includes a cache directory (112) that is a repository of information regarding cache lines in the caches. The directory records, for each cache line in all of the caches in the computer, the identity of the cache line or cache line “tag,” the cache line state, MODIFIED, SHARED, INVALID, and so on, and a bit vector that specifies for each processor whether a copy of a cache line in a low level shared cache is stored in an upper cache level. The MMUs (106) and the cache controllers (110) consult and update the information in the cache directory with every cache operation on a compute node. The cache controller (110), connected directly to L2, has no direct connection to L1—and obtains information about cache lines in L1 from the cache directory (112).

The cache controller (110) is a logic circuit that manages cache memory, providing an interface among processors (102), caches (L1, L2), and main memory (114). Although the cache controller (110) here is represented externally to the processors (102), cache controllers on modern computers are often integrated directly into a processor or an MMU. In this example, the MMUs (106) in fact include cache control logic for the L1 caches.

In the example of FIG. 1, the cache controller (110) replaces cache lines from L2 according to a cache replacement policy (303). When cache controller (110) receives a memory instruction, such as a LOAD or STORE, that requires replacement of a cache line in the low level shared cache, the cache controller selects for replacement a least recently used cache line in the low level shared cache L2 that has no copy stored in any higher level cache, which in this example is only L1. Not all memory instructions require cache line replacement. Some memory instructions, for example, are directed exclusively to main memory, string copies, cache purge instructions, IBM zSeries MVCL (Move Character Large) commands, Direct Memory Access (‘DMA’) operations by peripheral devices, and so on. Selecting a least recently used cache line that has no copies in any higher level cache reduces the risk of a premature eviction of such a cache line, an eviction that can be premature under traditional LRU because the fact that the cache line is copied in higher level caches is an indication that the cache line, at least some of the time, is more useful in cache than more recently used cache lines that have no copies in higher level caches.

In some embodiments, the shared cache is required by cache management policy to include a copy of each cache line stored in any higher level cache, a policy referred to as ‘strict inclusion.’ With strict inclusion, replacing a cache line in low level shared cache requires evicting all copies of that cache line from all higher level caches. Selecting a least recently used cache line that has no copies in any higher level cache eliminates such a burdensome premature eviction of the cache line from all of those higher level caches.

TABLE 1
Example Cache Directory

| Tag | State | Bit Vector | LRU Bits |
|---|---|---|---|
| 0010001100 | M | 011000 | 00000000 |
| 0000010110 | M | 000110 | 00000001 |
| 0001110011 | S | 000000 | 00000010 |
| 1001100101 | S | 000111 | 00000011 |
| 1011001111 | S | 000000 | 00000100 |

Cache line replacement according to embodiments of the present invention is further explained with reference to Table 1. Table 1 represents an example cache directory, and each record of Table 1 is a directory entry representing a cache line stored somewhere in the overall cache system of the computer (100). The example cache directory is presented here in table form, but readers will recognize that this is only for ease of explanation, not a limitation of the present invention. Cache directories useful in cache line replacement according to embodiments of the present invention are implemented in many forms, including, for example, arrays of memory, linked lists, C-style structures, and so on. For ease of explanation, the example cache directory of Table 1 is presented with only five entries, although readers will recognize that such cache tables typically include many entries.

Each entry in the example cache directory of Table 1 includes a cache tag that identifies a particular cache line. Each entry also includes a cache line state, in this example ‘M’ for MODIFIED and ‘S’ for SHARED. Each entry also includes a bit vector that specifies for each processor whether a copy of a cache line in a low level shared cache is stored in an upper cache level. With six bits, the bit vector specifies copies of cache lines for six processors. The first bit vector, 011000, specifies that the second and third of six processors possess in an upper cache level a copy of a cache line in a low level shared cache. The second bit vector, 000110, specifies that the fourth and fifth of six processors possess in an upper cache level a copy of a cache line in a low level shared cache. The fourth bit vector, 000111, specifies that the fourth, fifth, and sixth of six processors possess in an upper cache level a copy of a cache line in a low level shared cache. The third directory entry and the fifth directory entry both have bit vector values of 00000, indicating that no copies of those two cache lines in the low level shared cache are stored in any higher level cache. As among the five directory entries in the example cache directory of Table 1, only the cache lines represented by the third and fifth directory entries, tagged 0001110011 and 1011001111 respectively, can be replaced in a low level shared cache without risking a premature eviction. And in the example of a cache system requiring strict inclusion, only the cache lines represented by the third and fifth directory entries, tagged 0001110011 and 1011001111 respectively, can be replaced in a low level shared cache without incurring the burdensome cache management overhead of invalidating cache lines in higher level caches.

In addition to Tag, State, and Bit Vector, each entry in the example cache directory of Table 1 also includes recency-of-use information in the form of LRU bit values in a field named ‘LRU Bits,’ and the entries in the example cache directory of Table 1 are sorted on the LRU Bit field. The LRU Bit field in this example is implemented as a binary integer sequence, in effect, an integer time stamp with 256 possible values. A cache controller administers the LRU Bit field tracking the most recent LRU value, incrementing the LRU value and storing the incremented LRU value in the LRU Bit field of a cache line when that cache line is used in a memory operation. Among all cache lines, the cache line having the lowest LRU Bit value is least recently used. Among any subset of the cache lines, the cache line having the lowest LRU Bit value among the subset is least recently used.

In the example cache directory of Table 1, the third directory entry and the fifth directory entry have bit vector values of 00000, indicating that no copies of those two cache lines in the low level shared cache are stored in any higher level cache. And the LRU Bit values for the third directory entry and the fifth directory entry are 00000010 and 00000100 respectively, indicating that the third directory entry, tagged 0001110011, is, as between these two cache lines, least recently used. A cache controller using the example cache directory of Table 1, upon receiving a memory instruction that requires replacement of a cache line in the low level shared cache, selects for replacement the cache line represented by the third directory entry, tagged 0001110011, because that directory entry represents the least recently used cache line in the low level shared cache that has no copy stored in any higher level cache.

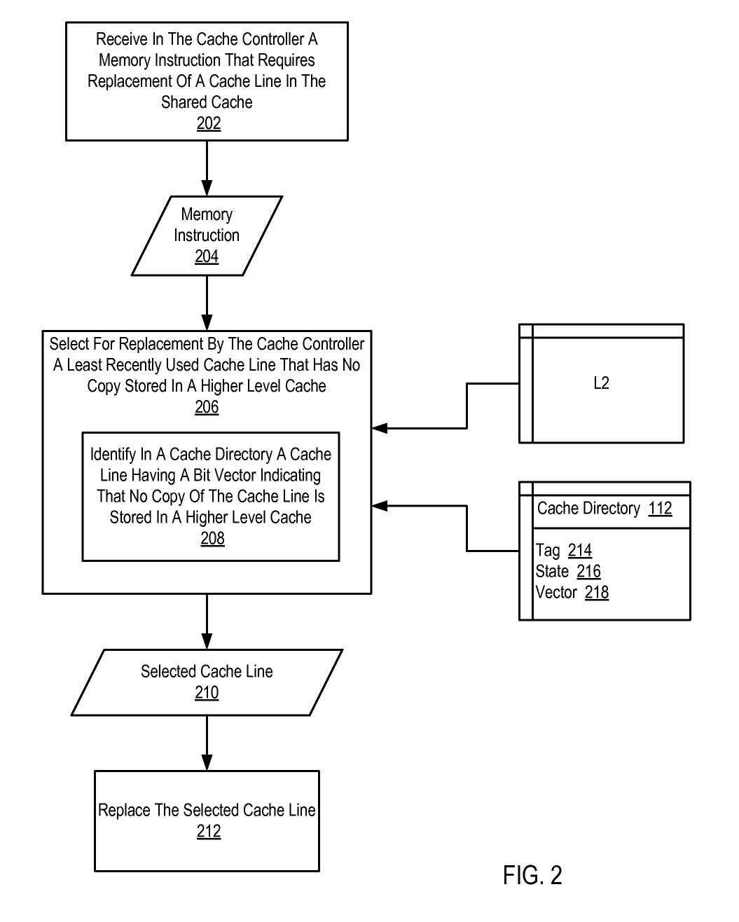

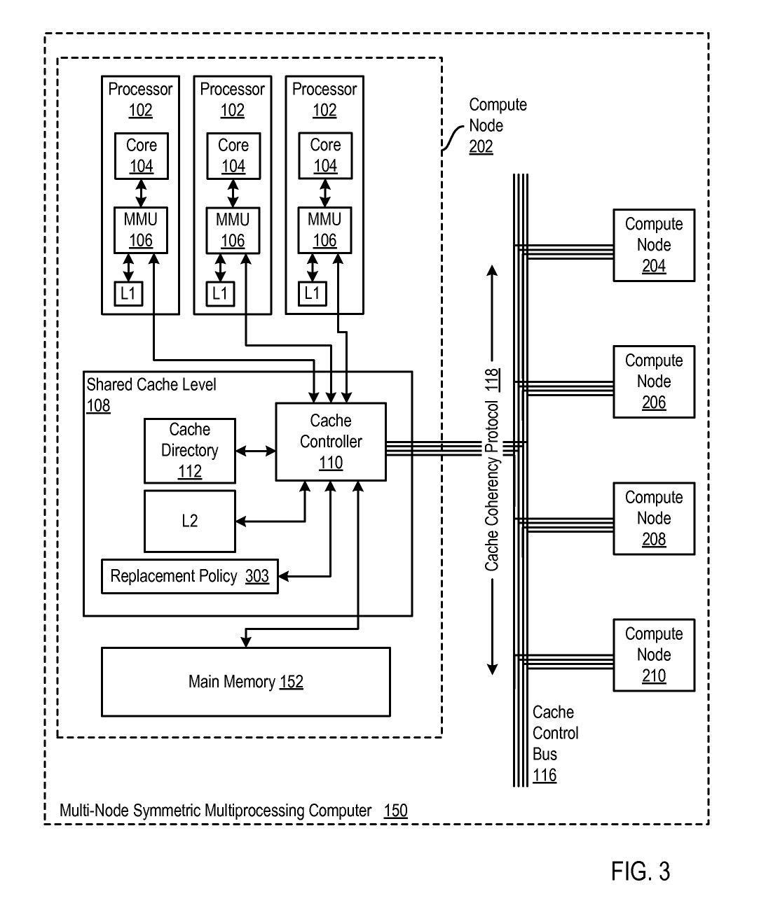

For further explanation, FIG. 2 sets forth a flow chart illustrating an example method of cache line replacement in a symmetric multiprocessing computer according to embodiments of the present invention. The method of FIG. 3 is implemented by and upon a symmetric multiprocessing computer (100) like the one illustrated and described above with reference to FIG. 1. The method of FIG. 3 is described here, therefore, with reference to both FIGS. 1 and 2, using reference numbers from each drawing. The computer (100) includes a plurality of processors (102), a plurality of cache levels (L1, L2) including at least one high level of private caches (L1) and a low level shared cache (L2), and a cache controller that controls the shared cache (L2).

The method of FIG. 2 includes receiving (202) in the cache controller (110) a memory instruction (204) that requires replacement of a cache line in the low level shared cache (L2). Not all memory instructions require cache line replacement. Some memory instructions are directed exclusively to main memory, string copies, cache purge instructions, IBM zSeries MVCL (Move Character Large) commands, Direct Memory Access (‘DMA’) operations by peripheral devices, and so on. Examples of memory instructions that may require cache line replacement include STORE operations that require a cache line from a higher level cache to be evicted from that higher level cache and replacing a cache line in the lower shared level cache with the cache line evicted from the higher level cache.

The method of FIG. 2 includes selecting (206) for replacement by the cache controller (110) a least recently used cache line in the low level shared cache (L2) that has no copy stored in any higher level cache (L1). Selecting (206) a cache line may include first selecting for replacement by the cache controller a least recently used cache line that has no copy stored in a higher level cache only if there are no invalid cache lines in the cache. That is, typically invalid cache lines are replaced first. If no invalid cache lines are in the low level shared cache, selecting a least recently used cache line that has no copies in any higher level cache reduces the risk of a premature eviction of such a cache line, an eviction that can be premature under traditional LRU because the fact that the cache line is copied in higher level caches is an indication that the cache line, at least some of the time, is more useful in cache than more recently used cache lines that have no copies in higher level caches.

In the method of FIG. 2, selecting (206) a cache line includes identifying (208) in a cache directory (112) a cache line having a bit vector (218) indicating that no copy of the cache line is stored in a higher level cache (L1). The cache directory (112) of FIG. 2 includes for each cache line in the caches (L1, L2) a ‘tag’ composed of most significant bits of the beginning address where the contents of the cache line are stored in main memory, the cache line state (216), MODIFIED, SHARED, INVALID, and so on, and a bit vector (218) that specifies for each processor whether a copy of a cache line in a shared cache is stored in an upper cache level. The bit vector may be implemented with a single bit for each processor as described with reference to Table 1. The bit for each processor currently having a copy of the cache line in a higher level cache is set true and therefore a cache line having a bit vector (218) indicating that no copy of the cache line is stored in a higher level cache (L1) may be carried out by identifying a cache line that has each bit of the vector set to false. The bit for the corresponding processor is set to FALSE, reset to 0, when the cache line is replaced from the higher level cache.

As mentioned, in some embodiments, the shared cache (L2) is required by cache management policy to include a copy of each cache line stored in any higher level cache (L1), a policy referred to as ‘strict inclusion.’ With strict inclusion replacing a cache line in low level shared cache requires evicting all copies of that cache line from all higher level caches. Selecting a least recently used cache line that has no copies in any higher level cache eliminates such a burdensome premature eviction of the cache line from all of those higher level caches.

Cache line replacement according to the present invention has been described above in the context of a single compute node computer. This is for explanation and not for limitation. Cache line replacement according to the present invention may be carried out in any computer having at least two processors each with high level private cache and having a lower level shared cache. For further explanation, therefore, FIG. 3 sets forth a functional block diagram of an example of a multi-node symmetric multiprocessing computer that implements cache line replacement according to embodiments of the present invention.

The example computer (150) of FIG. 3 includes several compute nodes (202, 204, 206, 208, 210). Actually the example of FIG. 3 illustrates a computer (150) with five compute nodes, but this number five is only for ease of explanation, not for limitation of the invention. Readers will recognize that SMP computers that implement horizontal cache persistence according to embodiments of the present invention can have any number of compute nodes. The IBM System z10™ series of mainframe computers, for example, each can include up to 64 compute nodes or, in z10 terminology, “frames.” The IBM Blue Gene™ series of supercomputers can support thousands of compute nodes.

The diagram of one of the compute nodes (202) is expanded to illustrate the structure and components typical to all of the compute nodes. Each compute node includes a number of computer processors (102). The number of computer processors per compute node is illustrated here as three, but this is for ease of explanation, not for limitation. Readers will recognize that each compute node can include any number of computer processors as may occur to those of skill in the art. The compute nodes in the IBM System z10 series of mainframe computers, for example, each can include up to 64 processors.

Each processor (102) in the example of FIG. 3 includes a compute core (104) that is coupled for memory operations through a memory management unit (‘MMU’) (106) and a cache controller (110) to two caches L1 and L2, and to main memory (152). L1 is a high level and relatively small, high speed cache fabricated into the processor itself The MMU (106) includes address translation logic, a translation lookaside buffer, controls for the on-processor cache L1, and so on. The cache controller (110), with the low level L2 cache, a cache directory (112), and a cache control bus (116) bearing data communications among the compute nodes according to a cache coherency protocol (118), implements a shared cache level (108) across the compute nodes (202, 204, 206, 208, 210) of the computer.

The main memory (152) is the principal, random access store of program data and program instructions for data processing on the computer (150). Main memory (152) is characterized by memory latency, the time required for a memory access, a read or write to or from main memory. Main memory (152) implements a single extent of physical address space, but main memory is physically segmented and distributed across compute nodes, so that a main memory access from a processor on one compute to a main memory segment on the same compute node has smaller latency than an access to a segment of main memory on another compute node. This segmentation of main memory is described here for ease of explanation of relative effects on latency, not for limitation of the invention. Main memory can be implemented off-compute node entirely in a single, non-segmented set, separately from processors on compute nodes exclusively dedicated to main memory, and in other ways as will occur to those of skill in the art. However main memory is implemented, though, it is always much slower than a cache hit.

In the example of FIG. 3, caches L1 and L2 implement a multi-level cache with two levels. Multi-level caches address the tradeoff between cache latency and hit rate. Larger caches have better hit rates but longer latency. To address this tradeoff, many computers use multiple levels of cache, with small fast caches backed up by larger slower caches. Multi-level caches generally operate by checking the smallest Level 1 (L1) cache first; if it hits, the processor proceeds at high speed. If the smaller cache misses, the next larger cache (L2) is checked, and so on, before main memory is checked. The example computer of FIG. 3 implements two cache levels, but this is only for ease of explanation, not for limitation. Many computers implement additional levels of cache, three or even four cache levels. Some processors implement as many as three levels of on-chip cache. For example, the Alpha 21164™ has a 96 KB on-die L3 cache, and the IBM POWER4™ has a 256 MB L3 cache off-chip, shared among several processors. In the example of FIG. 3, the L2 cache is shared directly among the processors on a compute node and among processor on all compute nodes through cache controller (110) on each compute node, the cache control bus (116), and the cache coherency protocol (118).

In the example of FIG. 3, the cache controller (110) in each compute node (202, 204, 206, 208, 210) replaces cache lines from L2 according to a cache replacement policy (303). When cache controller (110) receives a memory instruction that requires replacement of a cache line in the low level shared cache (L2), the cache controller selects for replacement a least recently used cache line in the low level shared cache L2 that has no copy stored in any higher level cache, which in this example is only L1. Selecting a least recently used cache line that has no copies in any higher level cache reduces the risk of a premature eviction of such a cache line, an eviction that can be premature under traditional LRU because the fact that the cache line is copied in higher level caches is an indication that the cache line, at least some of the time, is more useful in cache than more recently used cache lines that have no copies in higher level caches.

In some embodiments, the shared cache is required by cache management policy to include a copy of each cache line stored in any higher level cache, a policy referred to as ‘strict inclusion.’ With strict inclusion, replacing a cache line in low level shared cache requires evicting all copies of that cache line from all higher level caches. Selecting a least recently used cache line that has no copies in any higher level cache eliminates such a burdensome premature eviction of the cache line from all of those higher level caches.

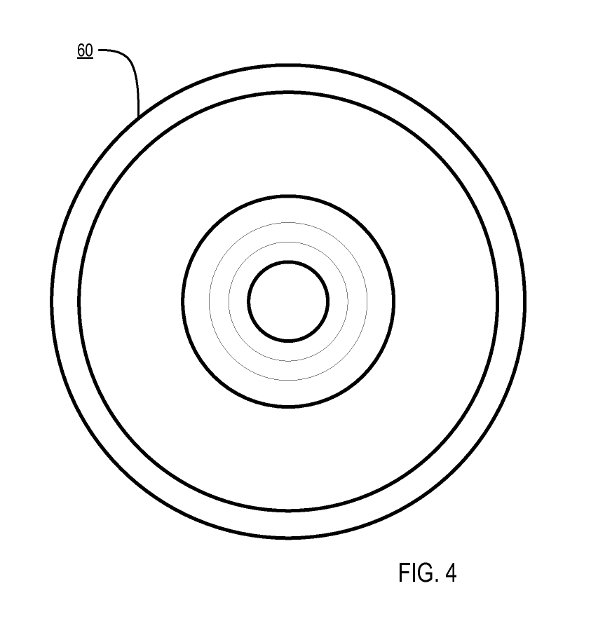

Example embodiments of the present invention are described largely in the context of a fully functional cache system for cache line replacement in a multi-compute node, SMP computer. Readers of skill in the art will recognize, however, that the present invention also may be embodied in a computer program product disposed upon computer readable storage media for use with any suitable data processing system, such as, for example, the computer readable media illustrated as an optical disk (60) on FIG. 4. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, that is as apparatus, or as a method or a computer program product. Accordingly, aspects of the present invention may take the form of an entirely hardware embodiment, embodiments that are at least partly software (including firmware, resident software, micro-code, etc.), with embodiments combining software and hardware aspects that may generally be referred to herein as a “circuit,” “module,” “apparatus,” or “system.” Furthermore, aspects of the present invention may take the form of a computer program product embodied in one or more computer readable media (e.g., optical disk (60) on FIG. 4) having computer readable program code embodied thereon.

Any combination of one or more computer readable media may be utilized. A computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture (e.g., optical disk (60) on FIG. 4) including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in a flowchart or block diagram may represent a module, segment, or portion of code or other automated computing machinery, which comprises one or more executable instructions or logic blocks for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of cache line replacement in a symmetric multiprocessing computer, the computer comprising a plurality of processors, a main memory that is shared among the processors, a plurality of cache levels including at least one high level of private caches and a low level shared cache, and a cache controller that controls the shared cache, the method comprising:
receiving in the cache controller a memory instruction that requires replacement of a cache line in the low level shared cache; and
selecting for replacement by the cache controller a least recently used cache line in the low level shared cache that has no copy stored in any higher level cache.

2. The method of claim 1 wherein selecting a cache line further comprises identifying in a cache directory a cache line having a bit vector indicating that no copy of the cache line is stored in any higher level cache.

3. The method of claim 1 wherein the shared cache includes a copy of each cache line stored in any higher level cache.

4. The method of claim 1 wherein selecting a cache line further comprises selecting for replacement by the cache controller a least recently used cache line that has no copy stored in a higher level cache only if there are no invalid cache lines in the cache.

5. The method of claim 1 wherein the computer comprises a multi-compute node, symmetric multiprocessing computer having a plurality of compute nodes, and each compute node includes:
a plurality of processors;
a segment of shared main memory;
a plurality of cache levels including at least one high level of private caches and a low level shared cache; and
a cache controller that controls the shared cache and is coupled for data communications to cache controllers on other compute nodes.

6. A symmetric multiprocessing computer with cache line replacement, the computer comprising a plurality of processors, a main memory that is shared among the processors, a plurality of cache levels including at least one high level of private caches and a low level shared cache, and a cache controller that controls the shared cache, the cache controller configured to function by:
receiving in the cache controller a memory instruction that requires replacement of a cache line in the low level shared cache; and
selecting for replacement by the cache controller a least recently used cache line in the low level shared cache that has no copy stored in any higher level cache.

7. The computer of claim 6 wherein selecting a cache line further comprises identifying in a cache directory a cache line having a bit vector indicating that no copy of the cache line is stored in any higher level cache.

8. The computer of claim 6 wherein the shared cache includes a copy of each cache line stored in any higher level cache.

9. The computer of claim 6 wherein selecting a cache line further comprises selecting for replacement by the cache controller a least recently used cache line that has no copy stored in a higher level cache only if there are no invalid cache lines in the cache.

10. The computer of claim 6 wherein the computer comprises a multi-compute node, symmetric multiprocessing computer having a plurality of compute nodes, and each compute node includes:
a plurality of processors;
a segment of shared main memory;
a plurality of cache levels including at least one high level of private caches and a low level shared cache; and
a cache controller that controls the shared cache and is coupled for data communications to cache controllers on other compute nodes.

11. A computer program product for cache line replacement in a symmetric multiprocessing computer, the computer comprising a plurality of processors, a main memory that is shared among the processors, a plurality of cache levels including at least one high level of private caches and a low level shared cache, and a cache controller that controls the shared cache, the computer program product comprising computer program instructions which when executed cause the cache controller to function by:
receiving in the cache controller a memory instruction that requires replacement of a cache line in the low level shared cache; and
selecting for replacement by the cache controller a least recently used cache line in the low level shared cache that has no copy stored in any higher level cache.

12. The computer program product of claim 12 wherein selecting a cache line further comprises identifying in a cache directory a cache line having a bit vector indicating that no copy of the cache line is stored in any higher level cache.

13. The computer program product of claim 12 wherein the shared cache includes a copy of each cache line stored in any higher level cache.

14. The computer program product of claim 12 wherein selecting a cache line further comprises selecting for replacement by the cache controller a least recently used cache line that has no copy stored in a higher level cache only if there are no invalid cache lines in the cache.

15. The computer program product of claim 12 wherein the computer comprises a multi-compute node, symmetric multiprocessing computer having a plurality of compute nodes, and each compute node includes:
a plurality of processors;
a segment of shared main memory;
a plurality of cache levels including at least one high level of private caches and a low level shared cache; and
a cache controller that controls the shared cache and is coupled for data communications to cache controllers on other compute nodes.
